(19) United States
(12) Patent Application Publication
(10) Pub. No.: US 2026/0241788 A1
(43) Pub. Date: Aug. 20, 2026

(54) DRIVE UNIT WITH DIFFERENTIAL AND BEARING SUPPORT ASSEMBLY

(71) Applicant: GKN Automotive Limited, Birmingham (GB)

(72) Inventors: Colin Zaers, Königswinter (DE); Hans-Joachim Schmeink, Lohmar (DE); Marco Wimmershoff, Solingen (DE); Artur Grunwald, Nümbrecht (DE); Brent M. Peura, Farmington, MI (US); Anthony M. Trimm, Hickory, NC (US)

(21) Appl. No.: 19/539,509

(22) Filed: Feb. 13, 2026

Related U.S. Application Data
(60) Provisional application No. 63/759,739, filed on Feb. 18, 2025.

(51) Int. Cl. B60K 17/346; B60K 17/04; F16H 48/08; F16H 48/40; F16H 57/021

(52) U.S. Cl. CPC B60K 17/346; B60K 17/046; B60K 17/3467; F16H 48/08; F16H 48/40; F16H 57/021

(57) ABSTRACT

A drive unit for a vehicle includes a differential having multiple differential gears and a housing, an input gear mounted on the housing for rotation with the housing, an input shaft driven for rotation about a first axis; a drive gear carried by the input shaft for rotation with the input shaft, the drive gear meshed with the input gear so that the input gear is rotated when the input shaft rotates, and a support bearing assembly. The support bearing assembly includes a first bearing member coupled to the input shaft and having a first bearing surface, and a second bearing member having a second bearing surface arranged to selectively be engaged by the first bearing member.

### REFERENCE TO RELATED APPLICATION

This application claims the benefit of U.S. Provisional Application Serial No. 63/759,739 filed on Feb. 18, 2025 the content of which is incorporated herein by reference in its entirety.

### TECHNICAL FIELD

The present disclosure relates generally to an automotive drive unit including a differential.

### BACKGROUND

Torque within a vehicle drivetrain tends to flex certain components, like shafts. Shaft bearings help to maintain alignment of shafts and gears and joints of the shafts. Some shafts extend into a casing and have a gear at the end and within the casing, the gear being meshed with another gear, such as an input gear of a differential. The shaft bearings are then spaced from the gear end of the shaft, and when the shaft is rotated in a direction associated with backward or reverse movement of the vehicle, a force exists between the shaft gear and input gear that tends to flex the shaft and separate the gears. The flexing or bending force on the input shaft can damage one or more components, such as the shaft bearings, and due to the reduced overlap/meshing of the gear teeth, can damage or cause failure of one or more teeth or of the gears.

### SUMMARY

In at least some implementations, a drive unit for a vehicle includes a differential having multiple differential gears and a housing, an input gear mounted on the housing for rotation with the housing, an input shaft driven for rotation about a first axis; a drive gear carried by the input shaft for rotation with the input shaft, the drive gear meshed with the input gear so that the input gear is rotated when the input shaft rotates, and a support bearing assembly. The support bearing assembly includes a first bearing member coupled to the input shaft and having a first bearing surface, and a second bearing member having a second bearing surface arranged to selectively be engaged by the first bearing member.

In at least some implementations, in a normal operating position of the input shaft, a gap is provided between the first bearing surface and the second bearding surface.

In at least some implementations, the second bearing surface is arranged to inhibit movement of the drive gear away from the ring gear.

In at least some implementations, the differential is received in a casing into which a portion of the input shaft extends, and wherein the second bearing member is carried by the casing. In at least some implementations, the drive gear is carried at or adjacent to a free end of the input shaft, and the first bearing member is received axially between the input shaft and the housing, relative to first axis.

In at least some implementations, the second bearing surface is part of an annulus. In at least some implementations, the second bearing surface spans between 45 degrees and 270 degrees.

In at least some implementations, at least part of the first bearing member rotates relative to the input shaft when the first bearing surface is engaged with the second bearing surface.

In at least some implementations, the second bearing member is arranged to be engaged by the first bearing member when forces on the drive gear move the drive gear in direction that reduces the engagement of the drive gear with the ring gear. In at least some implementations, the second bearing surface is part of an annulus and the second bearing surface spans between 45 degrees and 270 degrees.

In at least some implementations, the differential is received in a casing into which a portion of the input shaft extends, and the second bearing member is carried by the casing, the drive gear is carried at or adjacent to a free end of the input shaft, the first bearing member is received axially between the input shaft and the housing, relative to first axis, and the second bearing surface is not completely annular. In at least some implementations, the second bearing surface spans between 45 degrees and 270 degrees.

In at least some implementations, a method of assembling a drive unit for a vehicle, includes providing a casing, installing into the casing an input shaft having a drive gear that rotates with the input shaft and a first bearing member that is carried by the input shaft, installing a second bearing member into the casing and relative to the first bearing member, and installing differential gears into the casing.

In at least some implementations, the second bearing member is not completely annular and is installed into the casing in a location selected so that the first bearing member selectively engages the second bearing member.

In at least some implementations, in the installed position, a gap is provided between the first bearing surface and the second bearding surface. In at least some implementations, the second bearing surface is located so that, in operation of the drive unit, flexing of the input shaft in at least one direction is inhibited by engagement of the first bearing member with the second bearing member.

### BRIEF DESCRIPTION OF THE DRAWING

The following detailed description of preferred implementations and best mode will be set forth with regard to the accompanying drawings, in which:

FIG. 1 is a sectional view of part of a drive unit showing a differential, a ring gear on a housing of the differential and an input shaft arranged to drive the ring gear;

FIG. 2 is a diagrammatic end view of the input shaft including a bearing assembly;

FIG. 3 is a perspective view of part of the drive unit with a drive unit casing removed;

FIG. 4 is a side view of part of the drive unit; and

FIG. 5 is a partial sectional view showing the bearing assembly in the drive unit.

### DETAILED DESCRIPTION

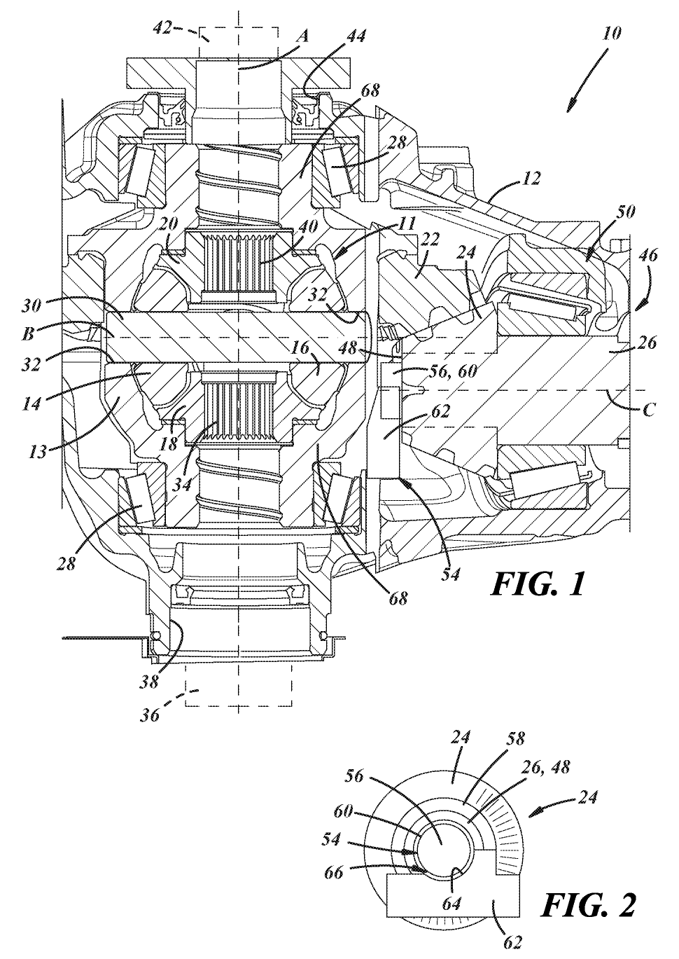

Referring in more detail to the drawings, FIG. 1 shows a vehicle drive unit 10 that can be equipped in an automotive driveline between, for example, side shafts of a front axle or a rear axle. In general, the drive unit 10 includes a differential 11 that can have different designs and constructions depending upon, among other possible influences, the architecture of the larger AWD automotive driveline, upstream and downstream driveline components, packaging requirements, and torque output demands. In the embodiments presented in the figures, the drive unit 10 includes a casing 12 in which the differential is received.

The differential 11 includes a housing 13, a first pinion gear 14, a second pinion gear 16, a first side gear 18, and a second side gear 20; and more, fewer, and/or different components can be included in other embodiments. For instance, the differential 11 could have more than two pinion gears, and could have three or four or more pinion gears. The housing 13 is coupled to an annular input gear, called a ring gear 22, at its exterior, and the ring gear 22 is coupled to a drive gear 24 of an input shaft 26 that is rotated by the vehicle powertrain (e.g. by an upstream output gear such as an output gear of a transmission in a front axle layout or that of a propeller shaft of the automotive driveline). When driven, the housing 13 rotates about an axis (A), and suitable bearings 28 may be provided between the housing 13 and the drive unit casing 12.

In assembly and use of the differential 11, teeth of the first pinion gear 14 mesh with the teeth of the first and second side gears 18, 20, and teeth of the second pinion gear 16 mesh with the teeth of the first and second side gears 18, 20. The first and second pinion gears 14, 16 include passages through which a pinion shaft 30 extends. The pinion shaft 30 has a center axis (B) and is mounted in openings 32 in opposite sides of the differential housing 13. The first side gear 18 has a set of internal splines 34 for connection to a first side shaft 36 an end of which is received in a first opening 38 of the housing 13, and the second side gear 20 has a set of internal splines 40 for connection to a second side shaft 42 an end of which is received in a generally oppositely facing second opening 44 in the housing 13. The side shafts 36, 42 are rotated about axis (A) in use.

The input shaft 26 extends into the casing 12 through a third opening 46, and carries the drive gear 24 at or near a free end 48 of the input shaft 26. The input shaft 26 rotates about an axis of rotation (C) and suitable bearings may be provided between the input shaft 26 and the casing 12, spaced from the drive gear 24. In at least some implementations, a first bearing 50, which may be called a head bearing, is provided adjacent to the drive gear 24. A second bearing 52, which may be called a tail bearing, is axially spaced from the head bearing 50 and axially farther from the drive gear 24, providing two locations of rotary support for the input shaft 26. The drive gear 24 and ring gear 22 have teeth that are meshed so that the ring gear 22 and differential housing 13 are rotated about axis (A) when the input shaft 26 rotates.

In at least some implementations, the axis of rotation (A) of the ring gear 22 and housing 13 is not parallel to and may be perpendicular to the axis of rotation (C) of the input shaft 26 and drive gear 24. In the example shown, the drive gear 24 and ring gear 22 are hypoid gears, although other gear types may be used, as desired. The teeth of the ring gear 22 and the drive gear 24 are arranged at an angle to the axes of rotation (A, C), and upon rotation of the input shaft 26 in a first direction, intended to cause forward movement of the vehicle, the torque is transferred from the input shaft 26 to the differential housing 13, through the drive gear 24 and the ring gear 22, and from the differential housing 13 to the side shafts 36, 42 via the differential gears 14, 16, 18 and 20.

When the input shaft 26 is rotated in the opposite, second direction, intended to cause backward or reverse movement of the vehicle, the torque flow path to the side shafts 36, 42 is the same. However, in this direction of rotation, a force exists between the drive gear 24 and ring gear 22 that tends to separate the gears. With the differential 11 and ring gear 22 firmly supported in the casing 12, the force tends to elastically flex or bend the input shaft 26 in a direction that lessens the mesh overlap of the drive gear teeth and ring gear teeth (e.g. moves the drive gear 24 away from the ring gear 22). Under normal operating forces, lower torque is demanded in reverse vehicle operation and this force is accommodated by the drive unit components (e.g. bearings 50, 52). However, under higher forces created during higher torque reverse vehicle operation, this flexing or bending force on the input shaft 26 can damage or cause failure of one or both bearings 50, 52, and due to the reduced overlap of the gear teeth, can damage or cause failure of one or more teeth, or of the meshed gears 22, 24.

In at least some implementations, to accommodate higher forces on the input shaft 26 in a direction that tends to separate the drive gear 24 from the ring gear 22, a support bearing assembly 54 is provided. The support bearing assembly 54 includes a first bearing member 56 that is carried by the input shaft 26 and that may be fixed for corotation with the input shaft 26, at the free end 48 of the input shaft 26. So located, the drive gear 24 is between the head bearing 50 and the first bearing member 56. The first bearing member 56 has a circular periphery, is coaxial with the drive gear 24, may have a smaller diameter than the drive gear 24, may have a smaller diameter than the free end 48 of the input shaft 26, and extends axially outwardly beyond an end face 58 of the drive gear 24 (relative to the input shaft axis of rotation (C)).

The first bearing member 56 may be a rotary bearing having an inner race fixed to the input shaft 26 and an outer race rotatably coupled to the inner race, and having a cylindrical outer surface that defines a first bearing surface 60 of the first bearing member 56. The first bearing member may be a non-rotating part such as a bushing or a projection integral with the end of the input shaft, by way of non-limiting examples. The first bearing member 56 can be formed of any desired material to provide a bearing surface permitting rotation relative to a second bearing member 62, as noted later. The first bearing member 56 may be formed, in at least some implementations, of cast iron, hardened steel, or sintered metals including but not limited to sintered bronze.

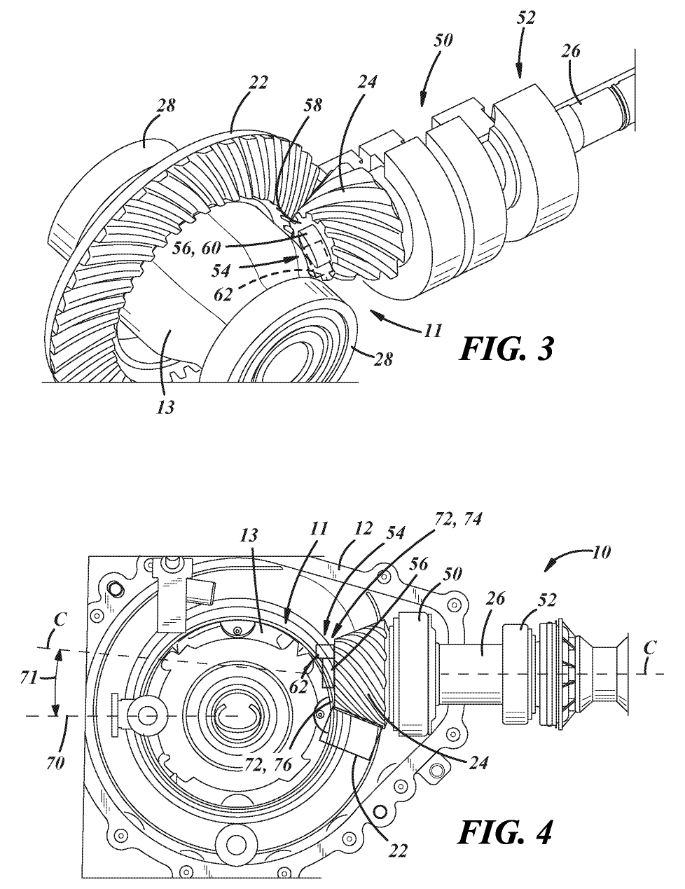

To limit movement of the first bearing member 56 and drive gear 24 away from the ring gear 22, the support bearing assembly 54 includes a second bearing member 62 arranged for rotary support of the first bearing member 56, in at least some operating conditions. The second bearing member is shown diagrammatically, by rectangles, in FIGS. 3 and 4, and in different, non-limiting forms in FIGS. 1, 2 and 5.

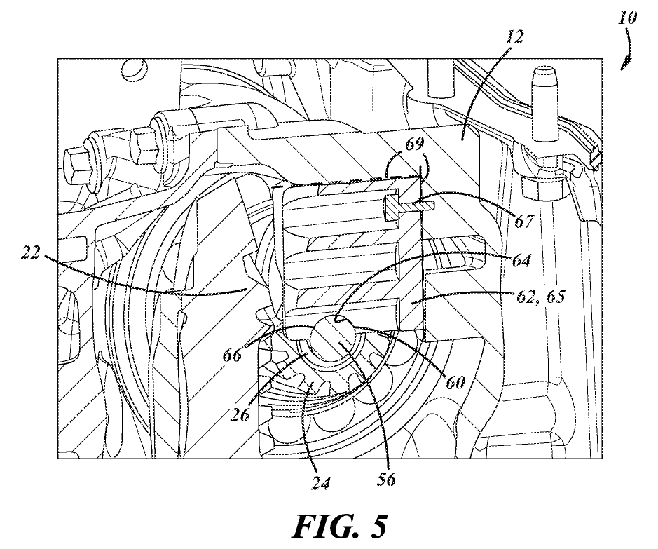

The second bearing member 62 is fixed in position, such as by being fixed to the casing 12 or a component that is fixed to the casing 12. The second bearing member 62 includes a second bearing surface 64 that is concave and complementary in shape to the first bearing surface 60 of the first bearing member 56. In at least some implementations, the second bearing surface 64 is not annular and is instead only a portion of an annulus. In some implementations, the second bearing surface 64 may be one-half (e.g. as generally shown in FIG. 5) to one-quarter (e.g. as generally shown in FIGS. 1 and 2) of an annulus (e.g. extend circumferentially between 90 and 180 degrees), although the second bearing surface 64 may span a greater or lesser circumferential extent. When the second bearing surface 64 of the second bearing member 62 is not completely annular, it can be received in a smaller area of the drive unit 10 without interference with the differential housing 13 which rotates within the casing 12 in use. In the example shown in FIG. 5, the second bearing surface 64 is defined in a body or bracket 65 that is fixed in the casing 12, such as by one or more bolts 67, and may have sides 69 that engage support surfaces of the casing, which may be complementarily arranged, to provide support for the second bearing member in use. The second bearing surface 64 may be a relatively smooth, fixed surface (e.g. not rotating), or could include one or more rotating elements (e.g. balls or needles or other rollers that may rotate relative to the body/bracket 65. The second bearing member 62 may be formed from materials noted herein for the first bearing member, and otherwise to support and permit rotation of the first bearing member relative to the second bearing member.

When the second bearing surface 64 of the second bearing member 62 is engaged by the first bearing surface 60 of the first bearing member 56, radial movement of the first bearing member 56 is prevented (relative to the axis of rotation of the input shaft 26 and first bearing member 56). In at least some implementations, such as is shown in FIGS. 2 and 5, a gap 66 is provided between the first bearing member 56 and the second bearing member 62 in a normal arrangement of the drive unit 10, and the first bearing member 56 only engages the second bearing member 62 when forces on the input shaft 26 cause movement of the first bearing member 56 toward the second bearing member 62. In the examples shown, this occurs during higher torque demanded operation of the vehicle in reverse, as noted earlier. Absent such force on the input shaft 26, the first bearing member 56 does not engage the second bearing member 62. The gap 66 between the first and second bearing surfaces 60, 64 may be made small so that radial deflection or flexion of the input shaft 26 is limited, to prevent overloading and damage to parts of the drive gear 24, ring gear 22 or other bearings (e.g. bearings 50, 52) associated with the input shaft 26.

In at least some implementations, the second bearing member 62 does not have a fully annular bearing surface 64. This may be done, for example, to reduce the size of the bearing member 62 which is desirable, for example, in automotive applications where conserving space and weight are priorities. Further, in at least some implementations, at least part of the second bearing member 62 is received axially between the differential housing 13 and the drive gear 24 (relative to the axis (A)). The partially annular second bearing surface 64 facilitates assembly of the second bearing member 62 into the casing, as set forth later.

Additionally, in at least some implementations, the input shaft 26 is radially offset from the pinion shaft 30 relative to the axis (C) of the input shaft 26. That is, an axis of rotation (B) of the pinion shaft 30 is offset from the axis of rotation (C) of the input shaft 26. In differentials having multiple pinion shafts, the pinion shaft 30 oriented in the same general direction as the input shaft 26 can be considered in this regard. Radially offset from the pinion shaft 30, and radially beyond the pinion gears, the differential housing 13 may taper or narrow toward ends 68 of the housing near the side shafts 36, 42 (and bearings 28), providing room in which the second bearing member 62 can be provided.

Also or instead of this offset, as shown in FIG. 4, the pinion shaft 30 may be inclined relative to (i.e. not parallel to) an imaginary plane 70 (e.g. at an angle 71 of, in at least some implementations, up to fifteen degrees that includes/is parallel to both the axis of rotation (A) of the side shafts 36, 42 and the axis of rotation (B) of the pinion shaft 30. This angling of the pinion shaft 30 provides a gap or open space 72 of varying size between the drive gear 24 and the free end 48 of the input shaft 26, with a maximum size open space 72 in one area 74 and a minimum size open space 72 in another area 76. The area 74 of the maximum open space, and locations near that area 74, provide additional space in which the second bearing member 62 may be received, as diagrammatically shown in FIG. 4. This can be done to avoid the need to make the ring gear 22 larger or to reduce the extent to which the ring gear 22 must be made larger or extend further from the differential housing 13 to accommodate the second bearing member 62.

In at least some implementations, the drive unit may be assembled by first installing the input shaft 26 with the drive gear 24 thereon, into the casing 12, with the input shaft 26 extending through the associated bearings 50, 52. This is done with a cover that defines part of the casing 12 removed, to expose the interior of the casing 12. Next, the second bearing member 62 can be inserted into and fastened in the interior of the casing 12, with the second bearing surface 64 radially outward of the first bearing surface 60, and axially aligned therewith, as shown in the drawings. Thereafter, the differential 11, with the ring gear 22 on the housing 13 thereof, can be installed into the drive unit. The partially annular second bearing surface 64 facilitates assembly into the drive unit casing 12, and provides clearance from the ring gear 22, while still supporting the first bearing member 56 and input shaft 26 against movement away from the ring gear 22, as noted herein.

It is to be understood that the above description is intended to be illustrative and not restrictive. Many embodiments and applications other than the examples provided would be apparent to those of skill in the art upon reading the above description. For example, various bearing or bushing or other relative rotational arrangements may be incorporated into and provided by the bearing support assembly 54, to allow rotation of the input shaft and first bearing member relative to at least part of the second bearing member. The scope of the invention should be determined, not with reference to the above description, but instead with reference to the appended claims, along with the full scope of equivalents to which such claims are entitled. It is anticipated and intended that future developments will occur in the arts discussed herein, and that the disclosed assemblies and methods will be incorporated into such future embodiments. In sum, it should be understood that the invention is capable of modification and variation that is limited only by the following claims.

All terms used in the claims are intended to be given their broadest reasonable constructions and their ordinary meanings as understood by those skilled in the art unless an explicit indication to the contrary in made herein. In particular, use of the singular articles such as "a," "the," "said," etc. should be read to recite one or more of the indicated elements unless a claim recites an explicit limitation to the contrary. In the preceding description, various operating parameters and components are described for one or more exemplary embodiments. These specific parameters and components are included as examples and are not meant to be limiting.

Reference in the preceding description to "one example," "an example," "one embodiment," "an embodiment", "an implementation" or "at least some implementations" means that a particular feature, structure, or characteristic described in connection with the example is included in at least one example or implementation including one or more but not necessarily all innovative features or components. References to various examples, embodiments or implementations do not necessarily refer to the same example, embodiment or implementation each time it appears.

1. A drive unit for a vehicle, comprising:
a differential having multiple differential gears and a housing;
an input gear mounted on the housing for rotation with the housing;
an input shaft driven for rotation about a first axis;
a drive gear carried by the input shaft for rotation with the input shaft, the drive gear meshed with the input gear so that the input gear is rotated when the input shaft rotates; and
a support bearing assembly including a first bearing member coupled to the input shaft and having a first bearing surface, and a second bearing member having a second bearing surface arranged to selectively be engaged by the first bearing member.

2. The drive unit of claim 1 wherein, in a normal operating position of the input shaft, a gap is provided between the first bearing surface and the second bearding surface.

3. The drive unit of claim 1 wherein the second bearing surface is arranged to inhibit movement of the drive gear away from the ring gear.

4. The drive unit of claim 1 which also includes a casing in which the differential is received and into which a portion of the input shaft extends, and wherein the second bearing member is carried by the casing.

5. The drive unit of claim 4 wherein the drive gear is carried at or adjacent to a free end of the input shaft, and the first bearing member is received axially between the input shaft and the housing, relative to first axis.

6. The drive unit of claim 1 wherein the second bearing surface is part of an annulus.

7. The drive unit of claim 6 wherein the second bearing surface spans between 45 degrees and 270 degrees.

8. The drive unit of claim 1 wherein the first bearing member does not rotate relative to the input shaft when the first bearing surface is engaged with the second bearing surface.

9. The drive unit of claim 1 wherein at least part of the first bearing member rotates relative to the input shaft when the first bearing surface is engaged with the second bearing surface.

10. The drive unit of claim 3 wherein the second bearing member is arranged to be engaged by the first bearing member when forces on the drive gear move the drive gear in direction that reduces the engagement of the drive gear with the ring gear.

11. The drive unit of claim 10 wherein the second bearing surface is part of an annulus and the second bearing surface spans between 45 degrees and 270 degrees.

12. The drive unit of claim 1 which also includes a casing in which the differential is received and into which a portion of the input shaft extends, and wherein the second bearing member is carried by the casing, the drive gear is carried at or adjacent to a free end of the input shaft, the first bearing member is received axially between the input shaft and the housing, relative to first axis, and the second bearing surface is not completely annular.

13. The drive unit of claim 12 wherein the second bearing surface spans between 45 degrees and 270 degrees.

14. A method of assembling a drive unit for a vehicle, including:
providing a casing;
installing into the casing an input shaft having a drive gear that rotates with the input shaft and a first bearing member that is carried by the input shaft;
installing a second bearing member into the casing and relative to the first bearing member; and
installing a differential into the casing.

15. The method of claim 14 wherein the second bearing member is not completely annular and is installed into the casing in a location selected so that the first bearing member selectively engages the second bearing member.

16. The method of claim 14 wherein, in the installed position, a gap is provided between the first bearing surface and the second bearding surface.

17. The method of claim 16 wherein the second bearing surface is located so that, in operation of the drive unit, flexing of the input shaft in at least one direction is inhibited by engagement of the first bearing member with the second bearing member.
